(19) United States
(12) Patent Application Publication
(10) Pub. No.: US 2015/0156943 A1
(43) Pub. Date: Jun. 11, 2015

(54) Multifunctional Utility Cart

(71) Applicant: Daniel Kenneth Bair, Bellbrook, OH (US)

(72) Inventor: Daniel Kenneth Bair, Bellbrook, OH (US)

(21) Appl. No.: 14/561,210

(22) Filed: Dec. 4, 2014

Related U.S. Application Data
(60) Provisional application No. 61/912,960, filed on Dec. 6, 2013.

(51) Int. Cl. A01B 49/06; A01B 45/02; A01B 41/00; A01C 7/08

(52) U.S. Cl. CPC A01B 49/06; A01C 7/085; A01B 45/02; A01B 41/00

(57) ABSTRACT

A multifunctional utility cart comprising a frame, at least two wheels attached to the bottom of the frame, a storage unit attached to the top of the frame with an opening at the base, an aerator, dethatcher and distributor attached to the bottom of the frame. The aerator and dethatcher can be engaged by lower a handle and can be disengaged by raising a handle. The top of the storage unit can be divided into two parts by lifting a hinged divider. The storage unit can be used for both storing lawn care products, including seed and fertilizer, and for placing seed and fertilizer for spreading on a lawn.

### CROSS-REFERENCE TO RELATED APPLICATIONS

Provisional Application No. 61/912,960

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable.

### MICROFICHE APPENDIX

Not Applicable.

### BACKGROUND

Homeowners and others who own property with lawns ordinarily desire to maintain a healthy and weed-free lawn. Various types of lawn care equipment is widely used by homeowners, gardeners and others who own property with lawns. For example, there are a variety of seeders and spreaders for applying seed and fertilizers, aerators for aerating the lawn, and dethatchers for dethatching lawns. Purchasing a separate seeder and spreader, aerator and dethatcher can be expensive and storing them can be difficult, taking up a lot of space and risking damage to the equipment.

Information relevant to attempts to address these problems can be found in U.S. Pat. Nos. 3,446,165, 3,544,013, 4,196,678, 4,609,151, 5,520,253, and 7,604,066. However, each one of these references suffers from one or more of the following disadvantages: all of the tools attached to the equipment cannot be used at the same time, the equipment is motorized, the equipment is large and heavy, and/or does not contain the same tools attached to the equipment.

For the foregoing reasons, there is a need for a multifunctional utility cart for use maintaining lawns that is inexpensive to manufacture, easy to store and contains the main functions for everyday lawn maintenance.

### SUMMARY

The present invention is directed to an apparatus that satisfies the need for a multifunctional utility cart that can be inexpensively manufactured, easily stored and can be used for basic lawn maintenance functions. The multifunctional utility cart having features of the present invention comprises a frame, a storage compartment attached to the top of the frame, at least two wheels attached to the bottom of the frame, a dethatcher, aerator, and distributor attached to the bottom of the frame. The distributor distributes at least seed or fertilizer.

### DRAWINGS

These and other features, aspects, and advantages of the present invention will come better understood with regard to the following description, appended claims, and accompanying drawings where:

FIG. 1 shows a perspective view of a preferred embodiment of the multifunctional utility cart of the subject invention with the aerator and dethatcher engaged;

FIG. 2 shows a perspective view of the multifunctional utility cart of FIG. 1 with the aerator and dethatcher disengaged;

FIG. 3 shows a top plan view of the multifunctional utility cart of FIG. 1; and

FIG. 4 shows a bottom plan view of the multifunctional utility cart of FIG. 1.

### DESCRIPTION

In the Summary and Description above, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components are optionally present. For example, an article “comprising” (or “which comprises”) components A, B, and C can consist of (i.e, contain only) components A, B, and C, or can contain not only components A, B, and C but also one or more other components.

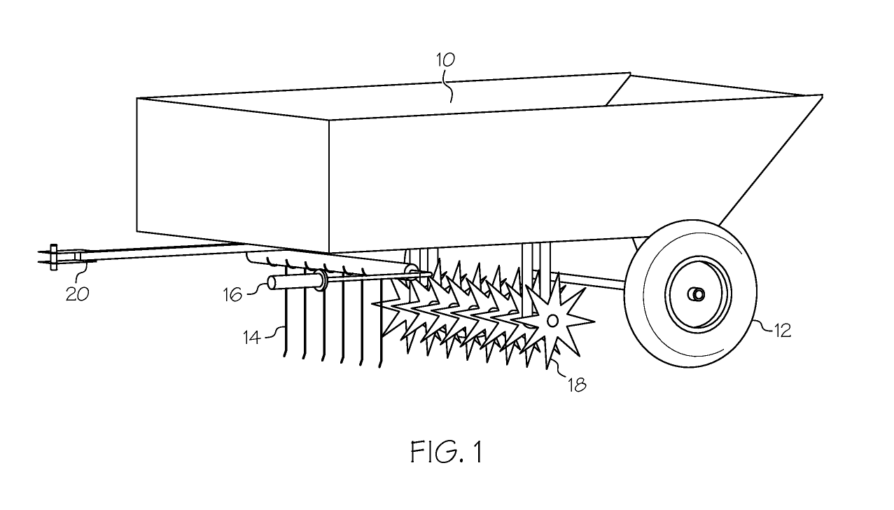

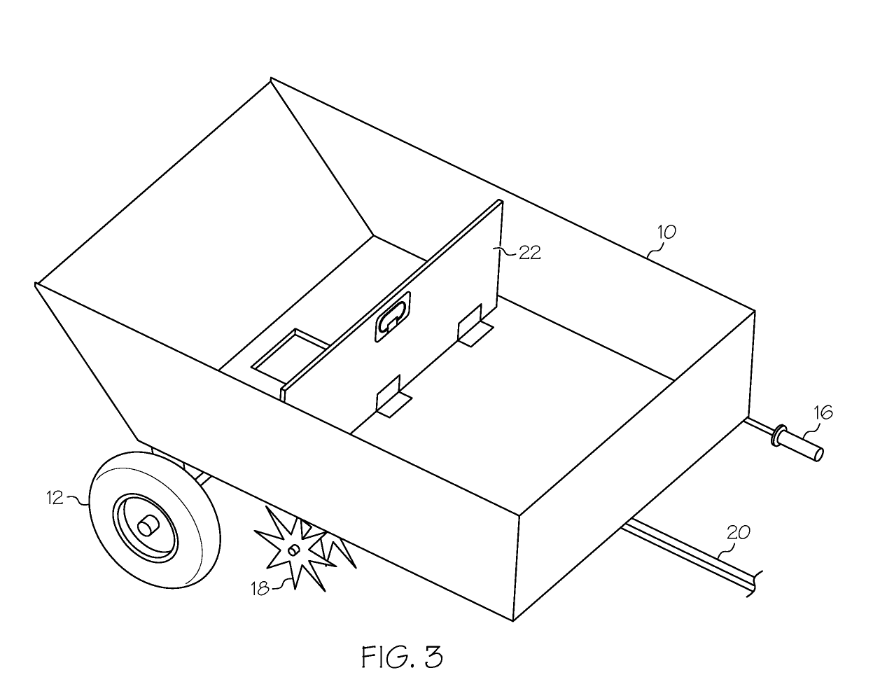

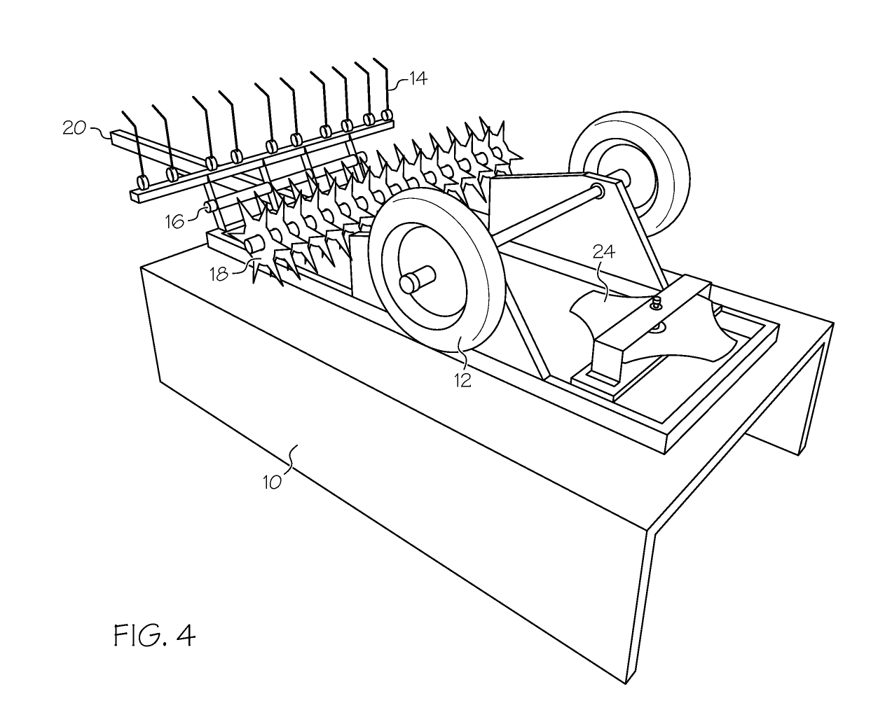

The present invention is directed to a multifunctional utility cart having a frame, at least two wheels attached to the bottom of the frame, a storage unit attached to the top of the frame, and an aerator, dethatcher and distributor attached to the bottom of the frame. With reference to the drawings, and particularly FIGS. 1 and 4, a multifunctional utility cart comprises a frame 20, a storage unit 10 attached to the top of the frame 20 and at least two wheels 12 attached to the bottom of the frame 20. The distal end of the frame 20 contains a hitch. The frame 20 can be made of a rigid material such as aluminum, steel, carbon steel, etc. The storage unit 10 can be made of a material such as plastic or thin metal. A distributor 24, dethatcher 14 and aerator 18 are attached to the bottom of the frame 20. As shown in FIG. 3, the storage unit 10 may contain a hinged divider 22, which can be lifted for separating the storage unit 10 into two compartments, one compartment to hold the contents for the distributor 24 and another compartment to serve as storage.

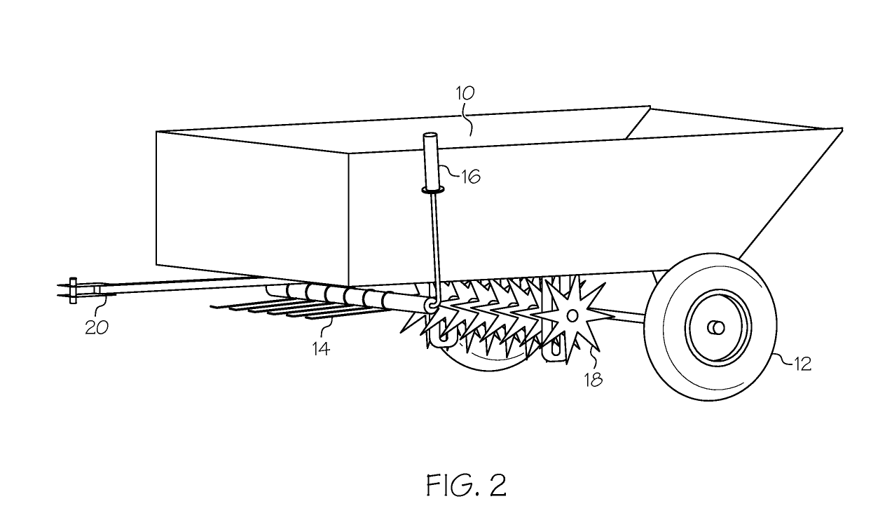

As shown in FIG. 1, a lever 16 can be lowered to lower and engage the dethatcher 14 and the aerator 18. As shown in FIG. 2, the lever 16 can be raised to raise and disengage the dethatcher 14 and the aerator 18. As shown in FIG. 3, seed or fertilizer can be placed in the storage unit 10 and distributed by the distributor 24.

As shown in FIG. 4, the distributor 24 is located on the frame 20 at the front of the multifunctional utility cart, the two wheels 12 attached to the frame 20 are located immediately posterior to the distributor 24, the aerator 18 is located immediately posterior to the two wheels 12, and the dethatcher 14 is located immediately posterior to the aerator 18.

The storage unit 10 can be used to store bags of fertilizer, seed or other lawn care items. The storage unit 10 can be used with the hinged divider 22 in a lowered position for maximum storage for fertilizer, seed or other lawn care items or in a raised position, as shown in FIG. 3, for decreased storage while the distributor 24 is engaged.

The hitch attached to the distal part of the frame 20 can be attached to a tractor, riding lawn mower or other motorized vehicle.

The multifunctional utility cart is used for basic lawn care and maintenance. The multifunctional utility cart may be pulled by a tractor, riding lawn mower or other motorized vehicle by attaching it to the hitch on the distal part of the frame 20. The multifunctional utility cart can dethatch, aerate and/or seed or fertilize a lawn.

The previously described versions of the present invention have many advantages, including (a) providing access to multiple tools at a single time of use; (b) combining multiple lawn tools into one tool, thereby saving the homeowner money and eliminating the need for additional storage space; and (c) replaceable and upgradeable tools. The multifunctional utility cart allows the user to complete their lawn maintenance without having to return to the garage or shed to obtain a different tool and without having to go over the same part of their lawn multiple times to complete the different tasks, such as aerating, dethatching, seeding and fertilizing. The user will need only purchase one item, the multifunctional utility cart, instead of numerous pieces of equipment, such as an aerator, dethatcher, and distributor, individually. The multifunctional utility cart allows the user to store one piece of equipment instead of numerous pieces of equipment in a garage and/or shed. The multifunctional utility cart allows the user to replace and/or upgrade the tools attached to the frame 20 when necessary or when desired.

Although the present invention has been described in considerable detail with reference to certain preferred versions thereof, other versions are possible. For example, (a) two handles can be used to independently deploy the dethatcher 14 and the aerator 18; (b) two handles can be used to deploy both the dethatcher 14 and the aerator 18 at the same time; (c) the frame 20 can have handles attached for manually pushing the multifunctional utility cart; and (d) additional or different lawn tools can be attached to the storage unit 10 or frame 20, such as a roller. Therefore, the spirit and scope of the appended claims should not be limited to the description of the preferred versions contained herein.

What is claimed is:

1. A utility cart comprising:
(a) a frame comprised of a rigid material comprising;
(i) a top; and
(ii) a bottom;
(b) a storage unit attached to the top of the frame comprising;
(i) a base attached to the top of the frame;
(ii) four walls, wherein each wall is perpendicular to and attached to the top outer edges of the base; and
(iii) an opening in the base of the storage unit;
(c) at least two wheels attached to the bottom of the frame;
(d) a dethatcher attached to the bottom of the frame;
(e) an aerator attached to the bottom of the frame;
(f) a handle attached to the dethatcher wherein the handle, when lowered, engages the dethatcher and the aerator and, when raised, disengages the dethatcher and the aerator; and
(g) a distributor attached to the bottom of the frame and under the opening in the base of the storage unit, wherein the distributor distributes at least one of seed or fertilizer.

2. A utility cart according to claim 1 wherein the storage unit includes a divider hinged to the top of the base of the storage unit such that the divider can be lifted to divide the storage unit into two compartments.

3. A utility cart according to claim 1 wherein the frame is comprised of metal.

4. A utility cart according to claim 1 wherein the storage unit is comprised of a single sheet of rigid material formed into a shape containing four walls.

5. A utility cart according to claim 1 wherein the frame contains a hitch attached to the distal end of the frame.
